(19) United States
(12) Patent Application Publication
(10) Pub. No.: US 2018/0127136 A1
(43) Pub. Date: May 10, 2018

(54) APPARATUS FOR AND METHOD OF PRODUCING AND/OR SEPARATING A STRING OF INTERCONNECTED PACKING CUSHIONS

(71) Applicant: Storopack Hans Reichenecker GmbH, Metzingen (DE)

(72) Inventor: Lukas Hagestedt, Esslingen am Neckar (DE)

(21) Appl. No.: 15/799,388

(22) Filed: Oct. 31, 2017

Related U.S. Application Data
(60) Provisional application No. 62/417,794, filed on Nov. 4, 2016.

(51) Int. Cl. B65B 61/12; B31D 5/00

(52) U.S. Cl. CPC B65B 61/12; B31D 5/0073; B31D 2205/0023; B31D 2205/0058; B31D 2205/0088

(57) ABSTRACT

Apparatus for producing a string of interconnected packing cushions comprises a packing cushion production machine which produces a string of interconnected packing cushions, and a packing cushion handler adapted to receive the string of interconnected packing cushions from the packing cushion production machine. The handler includes a separation plate. The separation plate is configured to support the string of interconnected packing cushions against force applied to the string of interconnected packing cushions in a direction towards and generally normal to the separation plate. The separation plate includes an opening therein which extends to a downstream end edge of the separation plate. The separation plate and opening are configured such that by extending one or more fingers of a single hand towards a line of perforations connecting adjacent packing cushions in a string of interconnected packing cushions, a packer is able contact the line of perforations, tear the line of perforations from a generally central location of the line of perforations outwardly towards each end of the line of perforations, grasp the downstream packing cushion, and separate it from the upstream cushion, all with a single hand.

### RELATED APPLICATIONS

This application claims the priority benefit of U.S. Provisional Patent Application No. 62/417,794 filed Nov. 4, 2016, which is hereby incorporated by reference herein as if fully set forth in its entirety.

### FIELD OF THE INVENTION

This invention relates generally to protective packaging products, and more specifically to an apparatus for and a method of producing and separating, or just separating, a string of interconnected packing cushions, for example air filled plastic pillows, into a desired length of cushions.

### BACKGROUND OF THE INVENTION

In the process of shipping an item from one location to another, a protective packaging material is typically placed in the shipping carton or box, to fill any voids and/or to cushion the item during the shipping process. One such protective packaging material is air filled cushions/pillows. Air filled pillows may be produced by a variety of commercially available air pillow production machines.

One method of tearing off a selected length of air cushions is shown and described in the assignee's U.S. Pat. No. 7,571,589, hereby incorporated by reference herein as if fully set forth in its entirety. In that patent, a packing cushion production machine produces a string of interconnected packing cushions. The string of interconnected packing cushions exits an output end of the machine at a first velocity. A separation device is associated with the output end of the machine. The separation device is adapted to selectively engage the string of interconnected packing cushions and to drive the string at a second velocity, greater than the first velocity. Doing so causes the string of interconnected packing cushions to separate. The separation device comprises a first moving surface adapted to contact one side of the string of interconnected packing cushions and a second moving surface adapted to be selectively placed into and out of contact with the other side of the string of interconnected packing cushions. The first and second moving surfaces can be belts.

Another method of tearing off a selected length of air cushions is to simply manually tear off a selected length, assisted by the perforations which separate adjacent air pillows. Such manual tearing off process, however, typically requires the use of both hands of the packer: one hand to grip the downstream air cushion and the other hand to grip the upstream air cushion. The packer then separates his/her hands to tear the adjacent air cushions apart along the line of perforations.

It would be desirable to devise a technique for manually separating a selected length of a string of air cushions from the remainder of the string of air cushions, thereby avoiding the expense and complexity of an automated separation device, but which can be performed with a single hand of the packer.

### SUMMARY OF THE INVENTION

In one aspect, apparatus for producing a string of interconnected packing cushions comprises a packing cushion production machine which produces a string of interconnected packing cushions, and a packing cushion handler adapted to receive the string of interconnected packing cushions from the packing cushion production machine. The handler includes a separation plate. The separation plate is configured to support the string of interconnected packing cushions against force applied to the string of interconnected packing cushions in a direction towards and generally normal to the separation plate. The separation plate includes an opening therein which extends to a downstream end edge of the separation plate. The separation plate and opening are configured such that by extending one or more fingers of a single hand towards a line of perforations connecting adjacent packing cushions in the string of interconnected packing cushions, a packer is able contact the line of perforations, tear the line of perforations from a generally central location of the line of perforations outwardly towards each end of the line of perforations, grasp the downstream packing cushion, and separate it from the upstream cushion, all with a single hand.

The packing cushions can be air cushions. The opening in the separation plate can be generally horseshoe shaped having a width at the downstream end edge of the plate which is narrower than a width of the opening at an upstream end of the opening.

In another aspect, a method of separating a string of interconnected packing cushions comprises providing the string of interconnected packing cushions, providing a separation plate configured to support the string of interconnected packing cushions against force applied to the string of interconnected packing cushions in a direction towards and generally normal to the separation plate, the separation plate including an opening therein which extends to a downstream end edge of the separation plate, extending one or more fingers towards a line of perforations connecting adjacent packing cushions in the string of interconnected packing cushions, contacting the line of perforations, tearing the line of perforations from a generally central location of the line of perforations outwardly towards each end of the line of perforations, grasping the downstream packing cushion, and separating it from the upstream cushion.

In another aspect, a packing cushion handler adapted to handle a string of interconnected packing cushions comprises a pair of side plates, a rotating member rotatably supported by the side plates, a hood supported by the side plates, and a separation plate depending from the side plates. The rotating member is adapted to draw the string of interconnected packing cushions upwardly into the hood and downwardly in front of the separation plate. The separation plate is configured to support the string of interconnected packing cushions against force applied to the string of interconnected packing cushions in a direction towards and generally normal to the separation plate. The separation plate includes an opening therein which extends to a downstream end edge of the separation plate. The separation plate and opening are configured such that by extending one or more fingers of a single hand towards a line of perforations connecting adjacent packing cushions in the string of interconnected packing cushions, a packer is able contact the line of perforations, tear the line of perforations from a generally central location of the line of perforations outwardly towards each end of the line of perforations, grasp the downstream packing cushion, and separate it from the upstream cushion, all with a single hand.

The separation plate can include a first generally planar portion oriented generally horizontally and having an upturned flange on either lateral side each of which is attached to a respective one of the side plates, a downwardly and inwardly turned lip along a rearward edge of the first planar portion, a second generally planar portion oriented generally vertically and extending downwardly from a forward edge of the first planar portion, an arcuate portion extending downwardly and forwardly from a lower edge of the second generally planar portion, and a third generally planar separation portion extending downwardly and forwardly from a lower edge of the arcuate portion, the separation portion including the opening, the opening being generally horseshoe shaped having a width at the downstream end edge of the plate which is narrower than a width of the opening at an upstream end of the opening.

In another aspect, a method of separating a string of interconnected air pillows comprises providing the string of interconnected air pillows, adjacent ones of which are separated by perforations at least near lateral edges of the string of interconnected air pillows, providing a separation plate configured to support the string of interconnected air pillows against force applied to the string of interconnected air pillows in a direction towards and generally normal to the separation plate, the separation plate including an opening therein which extends to a downstream end edge of the separation plate, extending one or more fingers of a single hand towards a region between adjacent air pillows in the string of interconnected air pillows, grasping the downstream air pillow, tearing the perforations laterally outwardly, and separating the downstream air pillow from the upstream air pillow.

In another aspect, a packing cushion separation device for separating a downstream packing cushion from an upstream packing cushion with a single hand of a user, the downstream and upstream packing cushions being in a string of interconnected packing cushions, adjacent ones of which are separated by perforations at least near lateral edges of the string of interconnected packing cushions, comprises a separation plate adapted to support the string of interconnected packing cushions against force applied to the string of interconnected packing cushions in a direction towards and generally normal to the separation plate, the separation plate including an opening therein which extends to a downstream end edge of the separation plate, thereby permitting the user to extend one or more fingers of the single hand towards a region between adjacent packing cushions in the string of interconnected packing cushions, grasp the downstream packing cushion, tear the perforations laterally outwardly, and separate the downstream packing cushion from the upstream packing cushion.

The packing cushions can be air pillows. The opening in the separation plate can be generally horseshoe shaped having a width at the downstream end edge of the plate which is narrower than a width of the opening at an upstream end of the opening. The plate can be oriented at an angle between vertical and horizontal. The separation plate can include an arcuate portion extending downwardly and forwardly and a generally planar separation portion extending downwardly and forwardly from a lower edge of the arcuate portion, the separation portion including the opening, the opening being generally horseshoe shaped having a width at the downstream end edge of said plate which is narrower than a width of the opening at an upstream end of the opening. The opening can include curved interior and exterior corners.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a perspective view of the air pillow handler and separation plate of the present invention.

FIGS. 2-4 illustrate the sequential steps in separating a string of interconnected packing cushions with the apparatus of FIG. 1.

FIG. 5 is a cross-sectional view taken along line 5-5 in FIG. 1.

FIG. 5A is a view similar to FIG. 5 but of an alternative embodiment of the separation plate.

FIG. 6 is a perspective view of the separation plate of FIG. 5A.

FIG. 7 is a front view thereof.

FIG. 8 is a side view thereof.

FIG. 9 is a perspective view of the separate plate with certain portions shown in dashed lines illustrating environment.

FIG. 10 is a front view thereof.

FIG. 11 is a back view thereof.

FIG. 12 is a side view thereof, the other side view being a mirror image thereof.

FIG. 13 is a top view thereof.

FIG. 14 is a bottom view thereof.

FIG. 15 is a front view thereof normal to the portion of the separation plate shown in solid lines.

### DETAILED DESCRIPTION OF THE DRAWINGS

The assignee's U.S. patent application Ser. No. 14/637,776 filed Mar. 4, 2015 is hereby incorporated by reference herein as if fully set forth in its entirety.

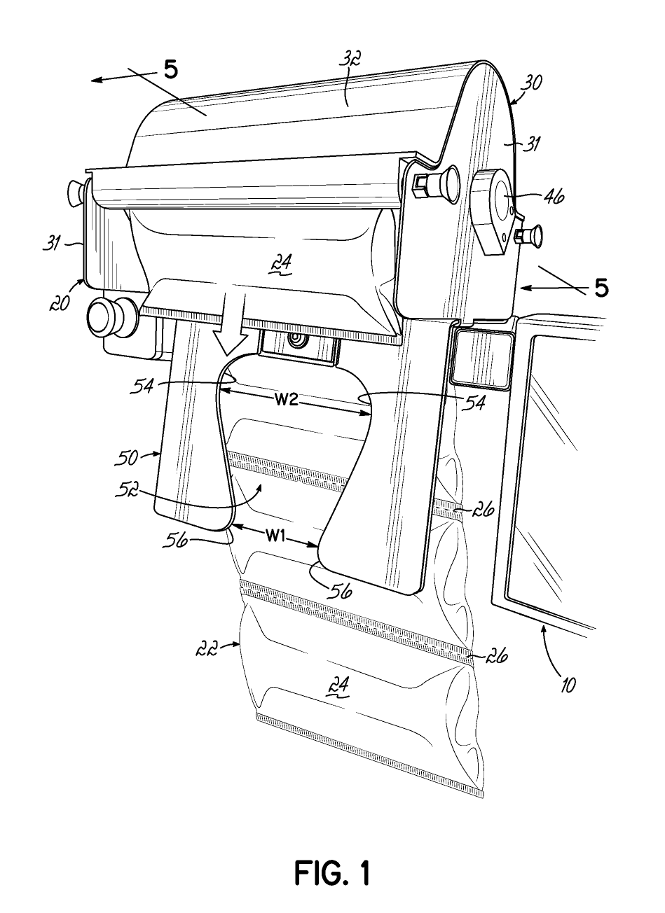

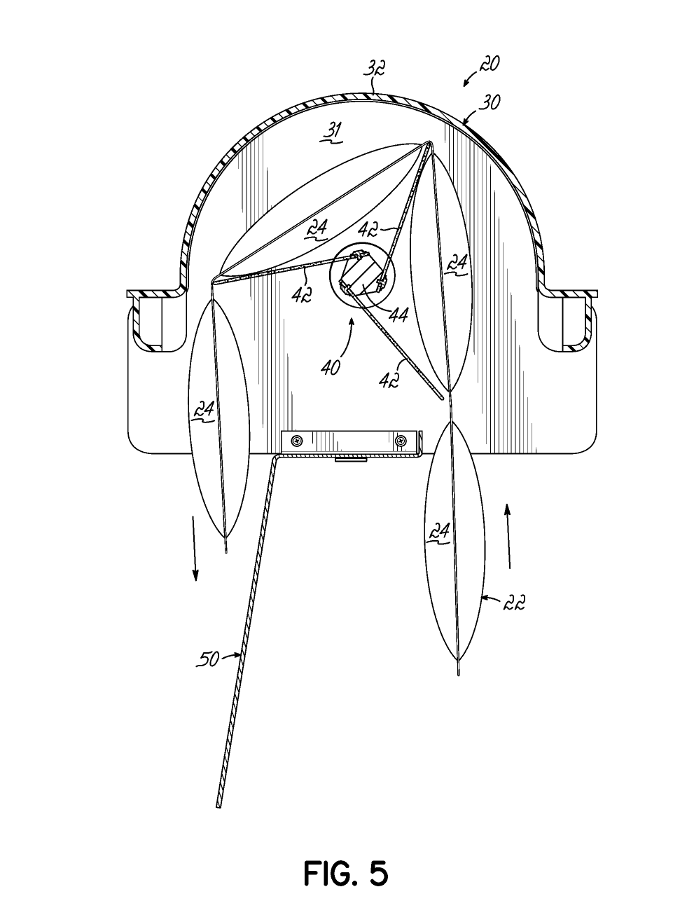

Referring first to FIGS. 1 and 5A, there is illustrated an air pillow production machine 10 and an air pillow handler 20 according to the principles of the present invention. Air pillow production machine 10 is of the known type of machine that forms a string 22 of interconnected air pillows 24 from a web of plastic film, the air pillows 24 separated by perforations 26 or a combination of perforations 26 and slits that permit separation of a desired length of air pillows 24 from the string 22 of air pillows 24. One such machine is shown in the assignee's U.S. patent application Ser. No. 14/637,776 filed Mar. 4, 2015 incorporated by reference above; the '776 application may be consulted for further details of such a machine 10.

The handler 20 includes a housing 30 having opposed side plates 31 and a hood 32 pivoted to the side plates 31 at 34. The hood 32 may be pivoted to an open position to permit access to the interior of the handler 20 and pivoted to a closed position during use of the handler 20. The handler 20 includes a motor driven rotating paddle mechanism 40 including a plurality of paddles 42 secured to a shaft 44 which is rotatably supported at opposite ends 46 to the side plates 31. The paddle mechanism 40 advances the string 22 of air pillows 24 upwardly, over the paddles 42, and then downwardly over a generally planar, downwardly and forwardly extending separation plate 50 mounted to housing 30.

The separation plate 50 includes a horseshoe-shaped opening 52 therein. The horseshoe-shaped opening 52 has a width w1 at a downstream end thereof which is narrower than a width w2 of the opening 52 at an upstream end thereof. The opening 52 has rounded or curved upper corners 54 and rounded or curved lower corners 56 to avoid puncturing air pillows during use, which will be described below.

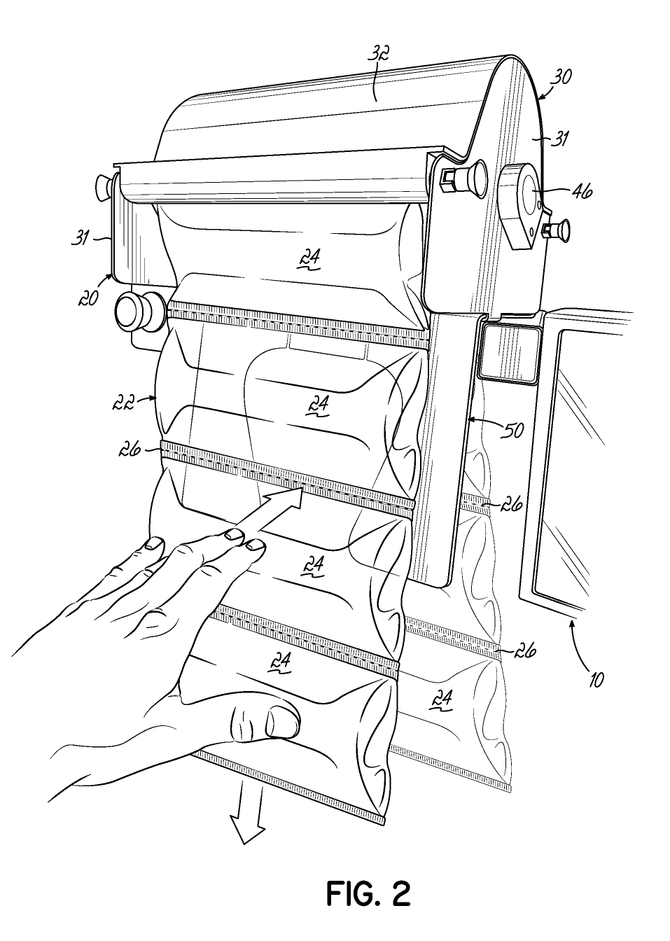

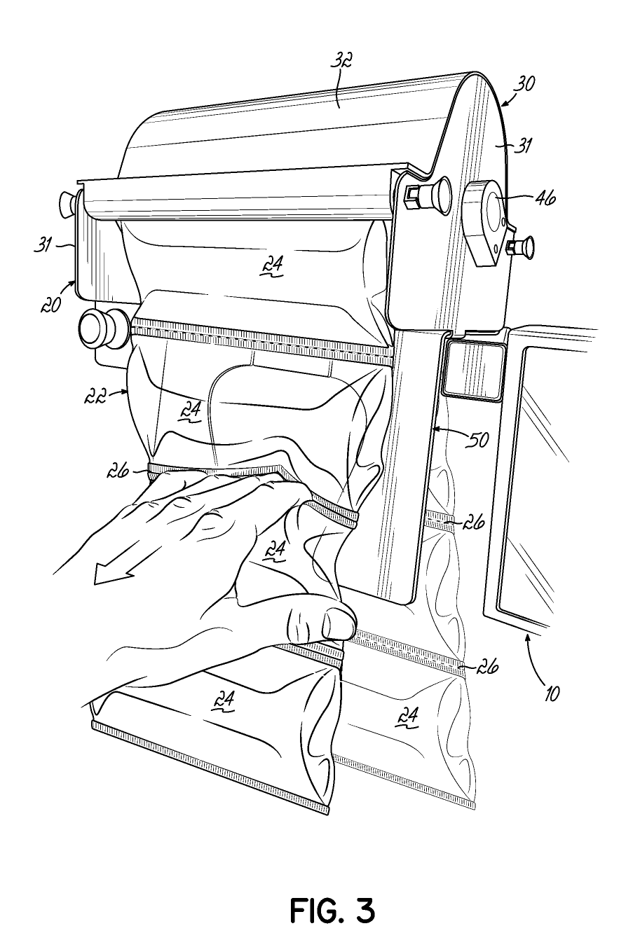

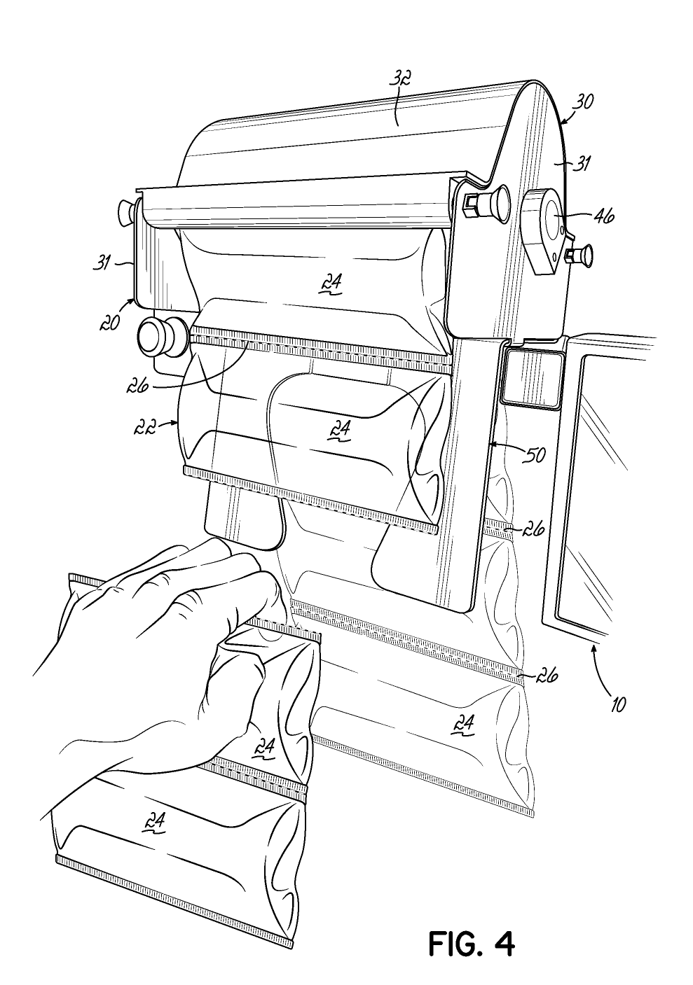

Referring now to FIGS. 2-4, use of the handler 20 will be described. The motor driven paddle mechanism 40 is actuated to dispense a selected length of interconnected air pillows 24 from the handler 20. The separation plate 50 supports the string 22 of interconnected air pillows 24 against a force applied to the string 22 of air pillows 24 in a direction towards and generally normal to the separation plate 50. A user extends one or more fingers of a single hand into contact with the line of perforations 26 interconnecting adjacent ones of the air pillows 24. Continued extension of the user's finger or fingers causes the line of perforations 36 to tear from a generally central location of the line of perforations 26 outwardly towards each end of the line of perforations 26. The user can then grasp the downstream air pillow 24, pull it downwardly with respect to the upstream air pillow 24, and fully separate the downstream air pillow 24 from the upstream air pillow 24, all with a single hand.

Note that while a continuous line of perforations 26 between adjacent ones of air pillows 24 is illustrated, the invention could readily be practiced with any combination of perforations and slits between air pillows 24. For example, one type of plastic film used in air pillow production machines utilizes a slit centrally located of the width of the plastic film, and a line of perforations outboard of each end of the central slit. Air pillows produced using such film also work with the handler 20 and separation plate 50 of the present invention.

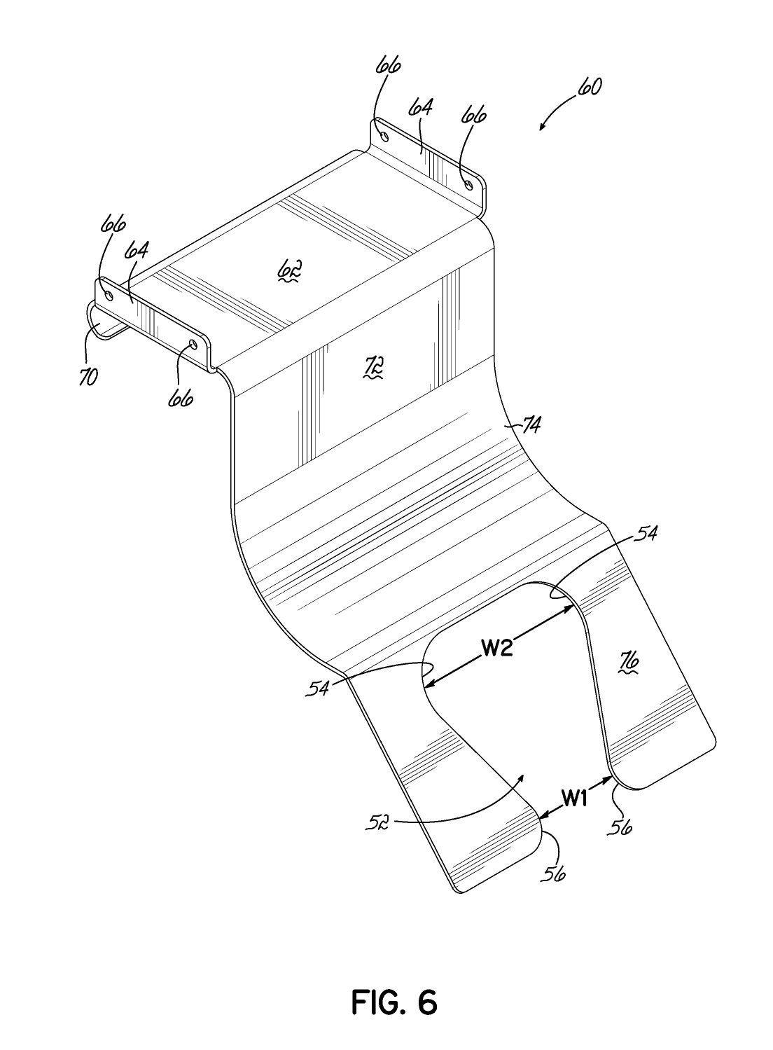

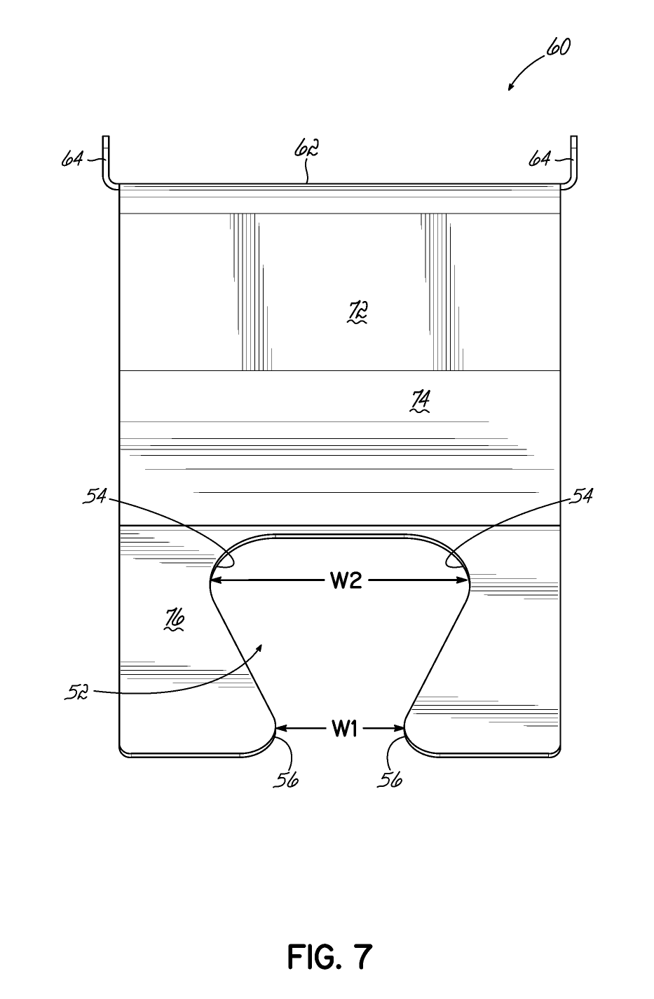

Referring now to FIGS. 5A-8, there is illustrated another embodiment 60 of separation plate according to the principles of the present invention. In this embodiment, the separation plate 60 includes a first generally planar portion 62, oriented generally horizontally, and having an upturned flange 64 on either side each of which includes a pair of screw holes 66 for attaching the plate 60 to the side walls 31 of the housing 30 with screws 68. The plate includes a downwardly and inwardly turned lip 70 along a rearward edge of the planar portion 62 to avoid puncturing air pillows 24 during use. A second generally planar portion 72, oriented generally vertically, extends downwardly from the forward edge of the planar portion 62. An arcuate or curved portion 74 extends downwardly and forwardly from the lower edge of the second generally planar portion 72. Finally, a third generally planar separation portion 76 extends downwardly and forwardly from the lower edge of the arcuate or curved portion 74, and includes the aforementioned opening 52, rounded or curved upper corners 54, rounded or curved lower corners 56, downstream width w1 and upstream width w2.

In the FIGS. 5A-8 embodiment, the vertical portion 72, curved portion 74, and separation portion 76 present the string 22 of air pillows 24 more conveniently to a user. In addition, the curved portion 74 reduces the tension in the upstream portion of the string 22 of air pillows 24 during separation thus reducing a tendency of the perforations 26 to tear in the region where the string 22 of air pillows 24 passes around the paddle mechanism 40.

Note that while the handler 20 is illustrated as being mounted to and used in conjunction with air pillow production machine 10, the handler 20 could just as well be a free-standing unit used in conjunction with a preformed string 22 of interconnected air cushions 24 stored in a bin or hopper or the like.

Note also that while the handler 20 is illustrated as used with interconnected strings 22 of air pillows 24, it could also be used with interconnected strings of paper cushions.

Note further that while the handler 20 is illustrated as including housing 30, hood 32, and motor driven rotating paddle mechanism 40, the handler could just as well simply be a support for supporting separation plate 50 or 60, as the technology of the present invention works as long as there is a string of packing cushions or air pillows stopped in front of it; it matters not whether the string comes directly off the packing cushion/air pillow production machine, through a drive mechanism, or is simply draped over it manually.

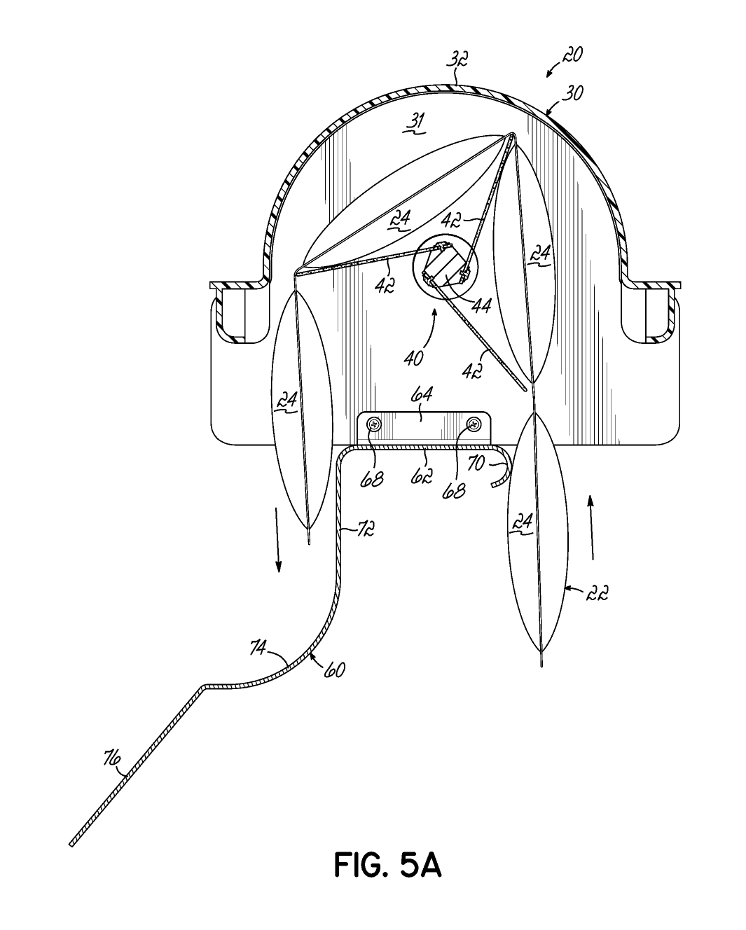

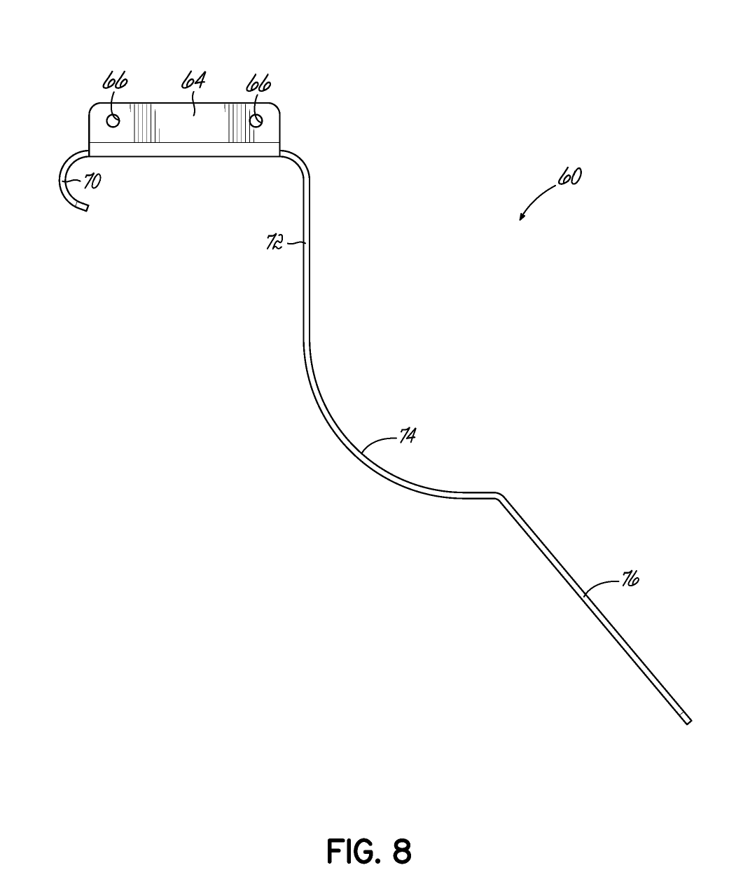

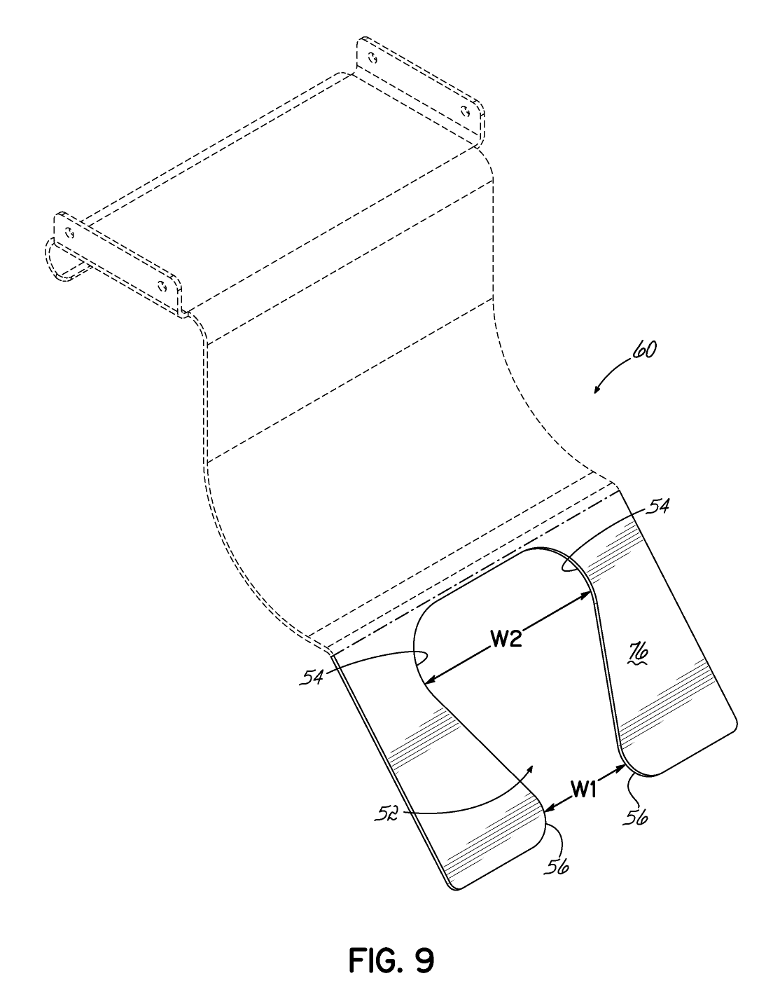

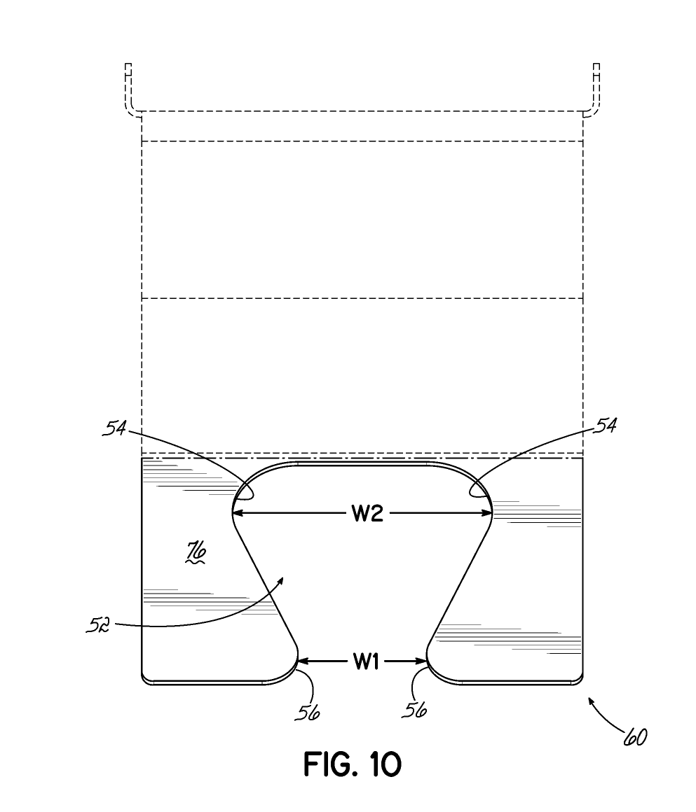

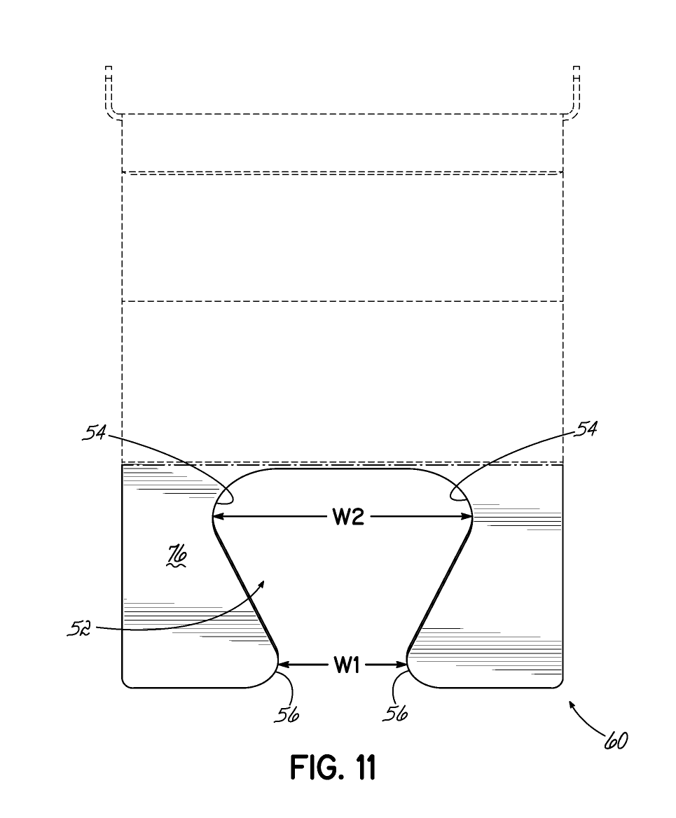

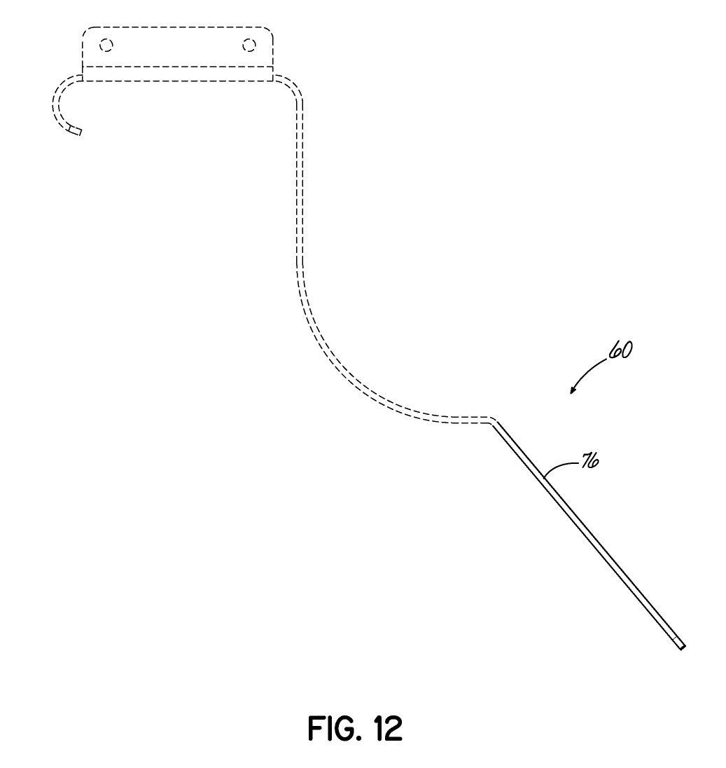

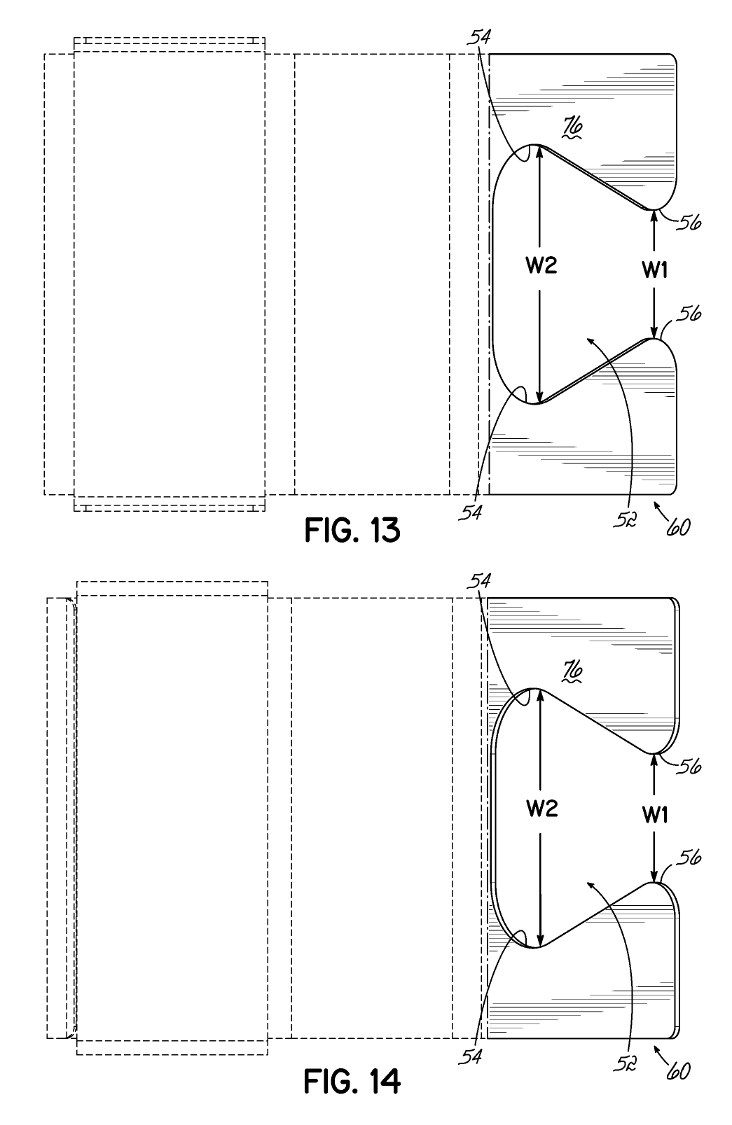

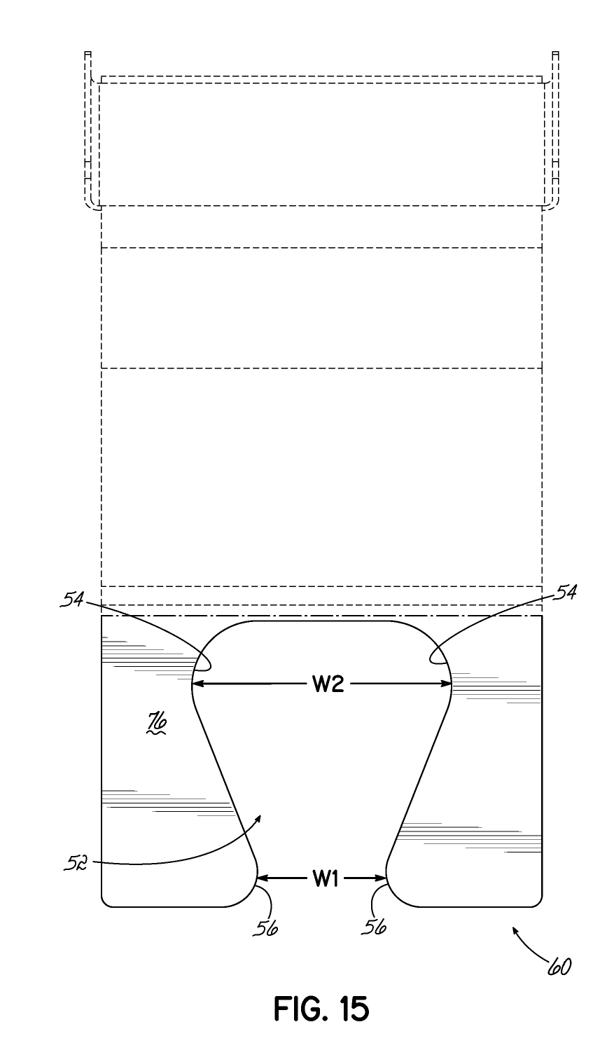

Finally, FIGS. 6-15 illustrate various ornamental features of the separation plate 60.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in all combinations of any and all of those features. Accordingly, the scope of the invention shall be limited only by the following claims and their equivalents.

What is claimed is:

1. Apparatus for producing a string of interconnected packing cushions, said apparatus comprising:
a packing cushion production machine which produces a string of interconnected packing cushions, and
a packing cushion handler adapted to receive the string of interconnected packing cushions from said packing cushion production machine, said handler including a separation plate,
said separation plate configured to support the string of interconnected packing cushions against force applied to the string of interconnected packing cushions in a direction towards and generally normal to said separation plate, said separation plate including an opening therein which extends to a downstream end edge of said separation plate,
said separation plate and opening configured such that by extending one or more fingers of a single hand towards a line of perforations connecting adjacent packing cushions in the string of interconnected packing cushions, a packer is able contact the line of perforations, tear the line of perforations from a generally central location of the line of perforations outwardly towards each end of the line of perforations, grasp the downstream packing cushion, and separate it from the upstream cushion, all with a single hand.

2. The apparatus of claim 1 wherein the packing cushions are air cushions.

3. The apparatus of claim 1 wherein said opening in said separation plate is generally horseshoe shaped having a width at said downstream end edge of said plate which is narrower than a width of said opening at an upstream end of said opening.

4. A method of separating a string of interconnected packing cushions comprising:
providing the string of interconnected packing cushions,
providing a separation plate configured to support the string of interconnected packing cushions against force applied to the string of interconnected packing cushions in a direction towards and generally normal to the separation plate, the separation plate including an opening therein which extends to a downstream end edge of the separation plate,
extending one or more fingers towards a line of perforations connecting adjacent packing cushions in the string of interconnected packing cushions, contacting the line of perforations, tearing the line of perforations from a generally central location of the line of perforations outwardly towards each end of the line of perforations, grasping the downstream packing cushion, and separating it from the upstream cushion.

5. The method of claim 4 wherein the packing cushions are air cushions.

6. The method of claim 4 wherein the opening in the separation plate is generally horseshoe shaped having a width at the downstream end edge of the plate which is narrower than a width of the opening at an upstream end of the opening.

7. A packing cushion handler adapted to handle a string of interconnected packing cushions, said handler comprising:
a pair of side plates,
a rotating member rotatably supported by said side plates,
a hood supported by said side plates, and
a separation plate depending from said side plates,
said rotating member adapted to draw the string of interconnected packing cushions upwardly into said hood and downwardly in front of said separation plate,
said separation plate configured to support the string of interconnected packing cushions against force applied to the string of interconnected packing cushions in a direction towards and generally normal to said separation plate, said separation plate including an opening therein which extends to a downstream end edge of said separation plate,
said separation plate and opening configured such that by extending one or more fingers of a single hand towards a line of perforations connecting adjacent packing cushions in the string of interconnected packing cushions, a packer is able contact the line of perforations, tear the line of perforations from a generally central location of the line of perforations outwardly towards each end of the line of perforations, grasp the downstream packing cushion, and separate it from the upstream cushion, all with a single hand.

8. The handler of claim 7 wherein the packing cushions are air cushions.

9. The handler of claim 7 wherein said opening in said separation plate is generally horseshoe shaped having a width at said downstream end edge of said plate which is narrower than a width of said opening at an upstream end of said opening.

10. The handler of claim 7 wherein said separation plate includes a first generally planar portion oriented generally horizontally and having an upturned flange on either lateral side each of which is attached to a respective one of said side plates, a downwardly and inwardly turned lip along a rearward edge of said first planar portion, a second generally planar portion oriented generally vertically and extending downwardly from a forward edge of said first planar portion, an arcuate portion extending downwardly and forwardly from a lower edge of said second generally planar portion, and a third generally planar separation portion extending downwardly and forwardly from a lower edge of said arcuate portion, said separation portion including said opening, said opening being generally horseshoe shaped having a width at said downstream end edge of said plate which is narrower than a width of said opening at an upstream end of said opening.

11. A method of separating a string of interconnected air pillows comprising:
providing the string of interconnected air pillows, adjacent ones of which are separated by perforations at least near lateral edges of the string of interconnected air pillows,
providing a separation plate configured to support the string of interconnected air pillows against force applied to the string of interconnected air pillows in a direction towards and generally normal to the separation plate, the separation plate including an opening therein which extends to a downstream end edge of the separation plate,
extending one or more fingers of a single hand towards a region between adjacent air pillows in the string of interconnected air pillows, grasping the downstream air pillow, tearing the perforations laterally outwardly, and separating the downstream air pillow from the upstream air pillow.

12. An packing cushion separation device for separating a downstream packing cushion from an upstream packing cushion with a single hand of a user, the downstream and upstream packing cushions being in a string of interconnected packing cushions, adjacent ones of which are separated by perforations at least near lateral edges of the string of interconnected packing cushions, said separation device comprising:
a separation plate adapted to support the string of interconnected packing cushions against force applied to the string of interconnected packing cushions in a direction towards and generally normal to said separation plate, said separation plate including an opening therein which extends to a downstream end edge of said separation plate,
thereby permitting the user to extend one or more fingers of the single hand towards a region between adjacent packing cushions in the string of interconnected packing cushions, grasp the downstream packing cushion, tear the perforations laterally outwardly, and separate the downstream packing cushion from the upstream packing cushions.

13. The device of claim 12 wherein the packing cushions are air pillows.

14. The device of claim 12 wherein said opening in said separation plate is generally horseshoe shaped having a width at said downstream end edge of said plate which is narrower than a width of said opening at an upstream end of said opening.

15. The device of claim 14 wherein said plate is oriented at an angle between vertical and horizontal.

16. The device of claim 12 wherein said separation plate includes an arcuate portion extending downwardly and forwardly and a generally planar separation portion extending downwardly and forwardly from a lower edge of said arcuate portion, said separation portion including said opening, said opening being generally horseshoe shaped having a width at said downstream end edge of said plate which is narrower than a width of said opening at an upstream end of said opening.

17. The device of claim 12 wherein said opening includes curved interior and exterior corners.
